(19) United States
(12) Patent Application Publication
(10) Pub. No.: US 2006/0178818 A1
(43) Pub. Date: Aug. 10, 2006

(54) On-board navigation system with a route preview and guiding instructions

(75) Inventor: Emmanuel Dhollande, Bissingen (DE)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, Toulouse Cedex (FR)

(21) Appl. No.: 10/558,067

(22) PCT Filed: May 13, 2004
(86) PCT No.: PCT/EP04/05138

§ 371 Date: Mar. 8, 2006

(30) Foreign Application Priority Data
May 23, 2003 (FR) 0306263

(51) Int. Cl. G01C 21/34

(52) U.S. Cl. 701/209; 701/201; 340/995.1

(57) ABSTRACT

The navigation system includes a route preview device, simultaneously displaying a map representation (21) of the route and guiding information (23). The information is superimposed on the map representation in connection with the point of the route to which the above apply. Rules for priority of display of guiding information and for the direction of display thereof are also defined.

The present invention pertains to an onboard navigation system, and more particularly to such a system comprising a previewing of the planned route, accompanied by corresponding guidance instructions.

Onboard navigation systems in motor vehicles generally comprise a cartographic database, means of calculation and means of display delivering information to the driver regarding the road to be followed in order to arrive at a destination chosen in advance. According to the system, two types of information are thus provided. In a first case, the information provided is a cartographic representation of the zone traveled, with highlighting of the road to be followed and a marker portraying the vehicle on said road. Such a representation is information rich, but may turn out to be complex and difficult to read, incurring a risk of distracting the driver while driving. In a second case, the information delivered is more ergonomic, confining itself to displaying, in the form of pictograms and/or vocal information, guidance instructions of the “turn right” type, etc. This information, although practical, does not enable the driver to establish where he is on his route.

Certain systems, such as for example that described in document DE 39 05 493, propose that the two modes of representation be juxtaposed by displaying a map on one screen, and guidance information on another, for example by projection onto the windscreen of the vehicle. Though this solution may present an advantage while moving, the same is not the case during the preparation thereof, when the driver, after having input his destination into the system, wants to view the route determined by the system in order to accept it or reject it. This solution is moreover very expensive since it requires two screens permanently. Other systems, such as that described in document U.S. Pat. No. 5,832,406 propose that the driver preview his route by sequentially displaying on the screen the various intersections that he will encounter, with an indication of the road to be followed at each intersection. These systems have the drawback of precluding an overall view of the chosen route.

The aim of the present invention is therefore to propose a navigation system which alleviates the drawbacks of the prior art by making the link between the route determined by the system and the guidance instructions that it will deliver while moving.

These aims of the invention, as well as others that will become apparent subsequently in the present description, are achieved by means of an onboard navigation system, comprising cartographic data, means of input of at least one destination, means of calculation of a route between an origin point and said destination, means of determination of guidance information on this route, and means of display, characterized in that the system comprises a device for previewing said route simultaneously displaying a cartographic representation of the route, and guidance information, said information being superimposed on the cartographic representation in relation to the point of the route to which it will be applicable.

According to an important characteristic of the present invention, the route is made up of hierarchized stretches of road, and the previewing device comprises means of determination of a scale of display of the cartographic representation and means of selection of the hierarchical level of the stretches of road to be displayed as a function of said scale of representation and of the guidance information displayed as a function of the hierarchical level of said stretches.

Advantageously, in case of conflict of display between several items of guidance information, the guidance information item relating to the stretch of highest hierarchical level will be displayed by priority.

According to another important characteristic of the invention, the guidance information is displayed such as it will be presented while traveling the route, and this whatever the orientation of the cartographic representation.

Other characteristics and advantages of the system according to the invention will become apparent on reading the description which follows and on examining the appended drawings in which:

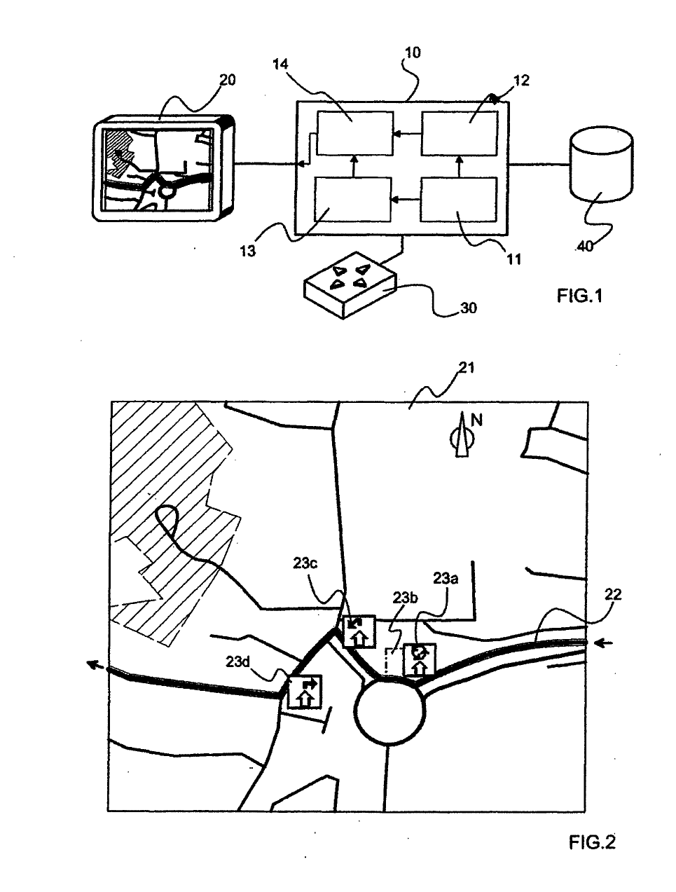

FIG. 1 represents a diagrammatic view of the navigation system according to the invention and,

FIG. 2 shows an exemplary cartographic representation provided by the previewing device according to the invention.

The navigation system represented in FIG. 1 conventionally comprises a computer 10 linked to a screen 20 for example a flat liquid crystal screen, to means of input 30 of data and instructions, such as a keypad, and to means of storage 40 comprising at least cartographic data pertaining to a determined region. The computer 10 consists, physically, of a microprocessor associated with peripheral circuits such as memories, input/output circuits such as a graphics interface, etc. which are not represented since they are known per se. The computer furthermore comprises software enabling it to fulfill numerous functions, of which only the functions useful for the account have been represented in the form of the functional blocks 11 to 14. The computer 10 therefore comprises route calculation means 11, which, on the basis of an origin point, in general the present position of the vehicle, and of a destination, either input directly by the means of input 30 or selected from an address book, calculates a route by selecting contiguous stretches of road from the cartographic data contained in the storage means 40. These various stretches of road do not all have the same importance, for example as a function of the nature of the carriageway. Specifically, when the route covers a movement from an address in a first town to another address in another town, it may comprise streets of the first town for reaching main roads, then trunk roads leading out of it, motorways linking the two towns, then, in proximity to the destination town, trunk roads, main roads and streets for reaching the exact destination address. A greater or lesser level of detail will be of interest depending on the part of the observed route, thus roads with heavy traffic and motorways alone may be of interest when observing the overall route, whereas small streets will be of importance if simply observing the part of the route corresponding to the movement within one of the origin or destination towns. Therefore the route calculated by the means of calculation 11 comprises not only the list of road stretches considered, but also information as to their hierarchy.

This route is then transmitted to cartographic representation means 12, adapted for preparing a representation of this route on a road map with a view to its display in this form on the screen 20. The route is thus highlighted on a map background by a track of different thickness and/or color from the track of the other roads represented. FIG. 2 shows an example of a cartographic representation 21 on which the route 22 has been represented with a thicker line than the other roads.

The route defined by the means of calculation 11 is also transmitted to means 13 of determining guidance instructions, the function of which is to determine for each junction between two contiguous stretches of road what instructions will be delivered to the driver as he travels along so as to enable him to perform the maneuver required to follow the calculated route. These guidance instructions may be presented in the form of pictograms 23 symbolizing the action to be undertaken and/or in the form of vocal messages. These guidance instructions are then appended to the road stretch during which they will have to be delivered to the driver to enable him to take the next stretch.

According to the essential characteristic of the invention, the means of cartographic representation 12 and of guidance instruction determination 13 deliver information that they have formulated to a previewing device 14. The latter uses this information to form, when requested by the driver, a combined display (see FIG. 2) consisting of a cartographic representation 21 of the route and of the guidance information 23 which will be presented while traveling, this information, in the form of pictograms 23a, 23c, 23d, being placed on the map approximately at the point where the vehicle will be located when the navigation system delivers it while moving.

Thus, as soon as the route has been determined, the latter can be displayed in the form of a map accompanied by guidance pictograms. This display may be performed automatically, or when requested by the driver by means of menu selection controlled by the input means 30. By default, this display is performed on a scale compatible with the route determined, enabling the whole of the latter to be shown. It is understood that therefore only the information of highest hierarchical level is displayed so as not to overload this representation. Thus, for example during a route linking two towns, only the roads and the motorways linking them will be shown, without entering into the detail of the streets of the towns. In accordance with the invention, the previewing device 14 will select, as a function of this scale, the hierarchical level of the stretches of road to be displayed and the guidance information 23 associated with them. The driver nevertheless retains the possibility of selecting a part of the representation displayed and of zooming in on the latter. The previewing device 14 determines, as a function of the part selected, an appropriate scale for the cartographic representation, and as a function of the latter, the hierarchical level of the stretches of road to be displayed, as well as the guidance information associated therewith.

Represented in FIG. 2 is a cartographic representation 21 corresponding to an intermediate scale, oriented northward, in which the route 22 represented in a thicker line is traveled from the right of the figure to the left thereof, as is suggested by the arrows (which are represented merely by way of information to aid the readability of the figure) on entry to and exit from the route.

It is noted that at the conclusion of the first stretch of road, a pictogram 23a is displayed in relation to this stretch, informing the driver that he is going to come to a roundabout. A second stretch corresponds to the arc traveled over this roundabout. Guidance information ought to be displayed in relation to this stretch. However, according to a characteristic of the invention, the previewing device 14 detects that the corresponding pictogram 23b represented by broken lines in the figure, involves a conflict of display with the pictogram 23a, these two pictograms partially overlapping. The previewing device 14 then compares the hierarchical level of the respective stretches, and in the presence, in the example represented, of a level of the first stretch that is higher than that of the second, eliminates the representation of the pictogram 23b so as not to overload the cartographic representation. It would also be possible to represent the pictogram 23a in the foreground, partly covering over the pictogram 23b, on account of the higher priority of the first over the second.

On continuing along the route 22 one encounters a pictogram 23c indicating the need to turn left at the conclusion of the third stretch, and a pictogram 23d indicating the need to turn right at the conclusion of the fourth stretch. It is then noted that, according to a characteristic of the invention, the latter pictogram is displayed such as it will be presented while traveling along the route. Specifically, the fourth stretch is traveled in the north-south direction, hence, although at first sight the next stretch seems to be oriented leftward, it will in reality be necessary to turn right to embark on it. An advantage of the representation according to the invention is thus noted whereby it is possible, without having to perform mental gymnastics consisting in reorienting the map in the direction of travel, to immediately perceive the maneuver that should be made at this point.

The onboard navigation system described hereinabove therefore allows the user to view, as soon as it is determined, the whole of the route that he will have to travel, with a possibility of more detailed viewing by means of a zoom, while familiarizing him with the guidance instructions that will be delivered to him by the system while traveling along this journey.

### LIST OF REFERENCES USED

1 Navigation system
10 Computer
11 Means of route calculation
12 Means of cartographic representation
13 Means of determining guidance instructions
14 Previewing device
20 Screen
21 Cartographic representation
22 Route
23a, b, c, d Guidance information
30 Input means
40 Cartographic data

1. An onboard navigation system (1), comprising cartographic data (40), means of input (30) of at least one destination, means of calculation of a route (11) between an origin point and said destination, means of determination of guidance information (13) on this route, and means of display (20), characterized in that the system comprises a device for previewing (14) said route simultaneously displaying a cartographic representation (21) of the route, and guidance information (23), said information being superimposed on the cartographic representation in relation to the point of the route to which it will be applicable.

2. The navigation system as claimed in claim 1, characterized in that the route (22) is made up of hierarchized stretches of road, and in that the previewing device (14) comprises means of determination of a scale of display of the cartographic representation and means of selection
of the hierarchical level of the stretches of road to be displayed as a function of said scale of representation and,
of the guidance information displayed as a function of the hierarchical level of said stretches.

3. The navigation system as claimed in claim 2, characterized in that, in case of conflict of display between several items of guidance information (23a, 23b), the guidance information item relating to the stretch of highest hierarchical level will be displayed by priority.

4. The navigation system as claimed claim 1, characterized in that the guidance information is displayed such as it will be presented while traveling the route, whatever the orientation of the cartographic representation.

5. The navigation system as claimed claim 2, characterized in that the guidance information is displayed such as it will be presented while traveling the route, whatever the orientation of the cartographic representation.

6. The navigation system as claimed claim 3, characterized in that the guidance information is displayed such as it will be presented while traveling the route, whatever the orientation of the cartographic representation.
